(19) United States
(12) Patent Application Publication
(10) Pub. No.: US 2005/0029413 A1
(43) Pub. Date: Feb. 10, 2005

(54) Wrist and forearm support for steadying an aim

(76) Inventor: Jimmy R. Bryant, Clarksville, TN (US)

Correspondence Address: BELSHEIM LAW OFFICE;STEPHEN T. BELSHEIM, 179 BELLE FORREST CIRCLE, SUITE 102, NASHVILLE,, TN, 37221, US

(21) Appl. No.: 10/637,302

(22) Filed: Aug. 8, 2003

(51) Int. Cl. F41B 11/00; B68G 5/00

(52) U.S. Cl. 248/118

(57) ABSTRACT

A support for use in supporting the arm of a user. The support comprises a cradle that receives the forearm of the user, a support that depends from the cradle, and a telescoping support that has an adjustable length. The telescoping support has opposite ends so that at one end is a brace and the depending support is pivotally connected to the other end of the telescoping support.

### BACKGROUND OF THE INVENTION

The invention pertains to a support for the arm of a bowhunter or other user. More specifically, the invention pertains to a support that steadies and supports the wrist and forearm of a bowhunter during the period of time that the bowhunter is aiming the bow.

Bowhunting is a popular sport. It is typical that a bowhunter will occupy a stand or other stationary hunting position from where one can observe the game animal (e.g., a deer). Once a bowhunter observes a game animal that is an appropriate target animal, typically, the bowhunter will take aim on the target animal. Even though the bowhunter has the target animal in his sights, it still may take some time for the bowhunter to have a clean unobstructed shot on the target animal. A clean unobstructed shot is especially important for bowhunting since obstructions can easily deflect the path of the arrow.

A compound bow sometimes weighs a number of pounds so that the prolonged unsupported holding of the compound bow may become very tiresome. In fact, it may take a great deal of strength on the part of the bowhunter to maintain a steady aim on a target animal.

A support that supports the bowhunter's arm while taking aim would be highly desirable. In addition, a support that helps steady the arm (and hence the aim) of the bowhunter would be highly desirable. Finally, a support that was adjustable in a number of different ways would be highly desirable.

### SUMMARY OF THE INVENTION

In one form thereof, the invention is a support for use in supporting the arm of a user. The support comprises a cradle that receives the forearm of the user, a support that depends from the cradle, and a telescoping-support that has an adjustable length. The telescoping support has opposite ends so that at one end is a brace and the depending support is pivotally connected to the other end of the telescoping support.

In another form thereof, the invention is a bowhunting support for a bowhunter. The support includes a cradle that receives the wrist and the forearm of a bowhunter. A strap is attached to the cradle wherein the strap secures the wrist and the forearm to the cradle. An articulating support depends from the cradle, and the articulating support has two articulating arms that articulate with respect to each other. The articulating support further includes a locking member that is movable between a locked condition in which the articulating arms are secured from relative movement and an unlocked condition in which the articulating arms are free to move relative to each other. The support further includes a telescoping support that has an adjustable length. The telescoping support has a pad at one end thereof. The telescoping support is connected at the other end thereof to the articulating support.

In yet another form thereof, the invention is a support for steadying the arm of a user. The support comprises a cradle that receives at least a part of the user's arm between the elbow and the wrist including the wrist. A first adjustable support extends from the cradle and has two arms that are movable with respect to each other. There is a locking member that selectively locks the two arms from relative movement with respect to each other. A second adjustable support has opposite ends wherein the axial length of the second adjustable support is adjustable. One end has a pad attached thereto and the other end is attached to the first adjustable support.

### BRIEF DESCRIPTION OF THE DRAWINGS

The following is a brief description of the drawings that form a part of this patent application:

FIG. 1 is an isometric view of a bowhunter that is grasping a compound bow and the bowhunter has a specific embodiment of the support attached to the arm adjacent to the forearm and the wrist;

FIG. 2 is an isometric view of the specific embodiment of the support of FIG. 1 attached to the arm of the user adjacent the wrist and forearm;

FIG. 3 is an isometric view of the specific embodiment of the support of FIG. 1 wherein the telescoping arm is extended and the cradle has one orientation to one side;

FIG. 4 is an isometric view of the specific embodiment of the support of FIG. 3 wherein the telescoping arm is contracted and the cradle has another orientation to another side;

FIG. 5 is an isometric view of another specific embodiment of the support wherein the cradle is in one position; and

FIG. 6 is an isometric view of the specific embodiment of FIG. 5 wherein the cradle is in another position.

### DETAILED DESCRIPTION OF SPECIFIC EMBODIMENTS

Referring to the drawings, FIG. 1 shows a bowhunter generally designated 20 grasping a compound bow 36 with his hand 32. The bowhunter 20 has one arm 22 that includes a forearm 24 and a wrist 26. The bowhunter 20 has another arm 28, as well as a torso 30. Although it will be described in more detail later, an adjustable support 40 is attached to the bowhunter's 20 one arm 22 at the wrist 26 and the forearm 24. The adjustable support 40 then permits the bowhunter 20 to brace his one arm 22 against his torso 30 so as to support the load (or at least part of the load) of holding and supporting the compound bow 36, and thus, reduce the load (at least some of the load) off of the user's one arm 22.

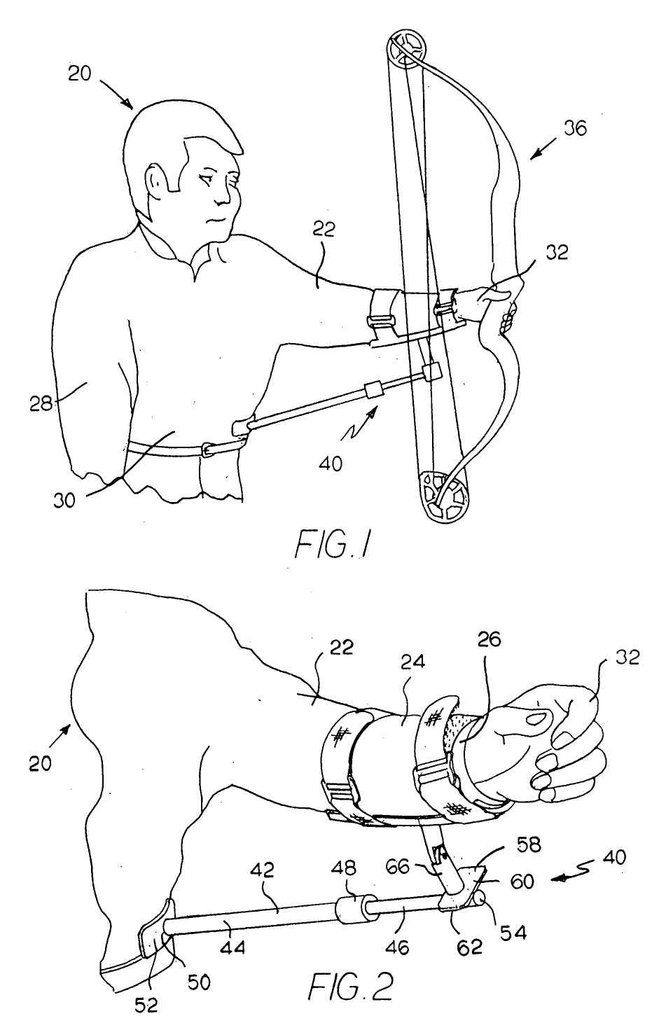

Referring in particular to FIGS. 2 through 4, the adjustable support 40 includes a telescoping arm 42 that comprises a larger diameter arm 44 and a smaller diameter arm 46 that slides inside the larger diameter arm 44 in an axial longitudinal fashion so that the axial length of the telescoping arm 42 can be varied. The telescoping arm 42 further includes a locking member 48. The locking member 48 is movable between one condition in which the larger diameter arm 44 and smaller diameter arm 46 are free to move relative to one another and a second (or other) condition in which the locking member 48 locks (or restrains) the larger diameter arm 44 and the smaller diameter arm 46 from moving relative to each other. Although it will be described hereinafter, it can be appreciated that the ability of the telescoping arm 42 to exhibit an adjustable axial length permits it to accommodate any specific user (or bowhunter).

The larger diameter arm 44 has a distal (or free) end 50. An arcuate support (or pad) 52 is attached to the distal end 50 of the larger diameter are 44. The arcuate support 52 permits the bowhunter 20 to brace his arm 22 against his torso 30 (e.g., hip) without any discomfort since the arcuate support 52 spreads the force that is exerted on the user's hip. While the arcuate support 52 presents a curvature that is intended to the conform to the curvature of the user's hip portion, it should be appreciated that the curvature or geometry could vary depending upon the particular user or situation.

The smaller diameter arm are 46 has a distal (or free) end 54 that is connected to the bottom surface 62 of a generally planar platform 58. The platform 58 also presents a top surface 60.

An upstanding arm 66 is attached at its bottom end 68 to the top surface 60 of the platform 58. The upstanding arm 66 further includes a top end 70. The upstanding arm 66 is connected at its top end 70 to the remainder of the adjustable support 40 as will be described hereinafter.

The adjustable support 40 further includes a forearm brace 80. Forearm brace 80 is of a generally rectangular shape and has a curvature so as to present a cradle 82 that has a top surface 84 and a bottom surface 86. A depending arm 88 is attached at its top end 90 to the bottom surface 86 of the cradle 82 and depends therefrom. The depending arm 88 further includes a bottom end 92.

The upstanding arm 66 is attached at its top end 70 to the bottom end 92 of the depending arm 88 so as to form an articulating joint. The upstanding arm 66 is movable relative to the depending arm 88. The ability of these arms (66, 88) to move relative to one another permits the brace 40 to be adjustable (or accommodate) a variety of users. There is a lock screw 96 at the articulating joint so as to either permit the arms 66 and 88 to move relative to each other or prohibit them relative movement. As can be appreciated, once the user has determined the appropriate relative positioning of the arms 66 and 88 they can lock down the relative position of these arms (66, 88) so as to customize the support 40 for a particular user.

The adjustable support 40 further includes a strap 100 that includes a buckle 102 and apposite Velcro surfaces 104 and 106. The support 40 also has another strap 110 that has a buckle 112 and Velcro surfaces.

To use the support 40, the bowhunter 20 first places his arm 22 in the support 40 so that the forearm 24 and the wrist 26 rest on the top 84 of the cradle 82. The straps 100 and 110 are then adjusted so as to be tight about the bowhunter's wrist and forearm. The buckle provides for the adjustment and the Velcro surfaces mate to provide a secure attachment. The articulating joint is then positioned and locked into place.

The bowhunter 20 then places the arcuate support (or pad) 52 against his torso 30 typically at or near the hip. The bowhunter 20 can then adjust secure the axial length of the telescoping arm 42 and adjust and secure the relative position of the arms 66 and 88. It can thus be seen that the bowhunter has a support that helps him support the load of holding the compound bow (especially when taking aim on a target) wherein the support 40 is adjustable in a number of different ways so as to accommodate users of various sizes.

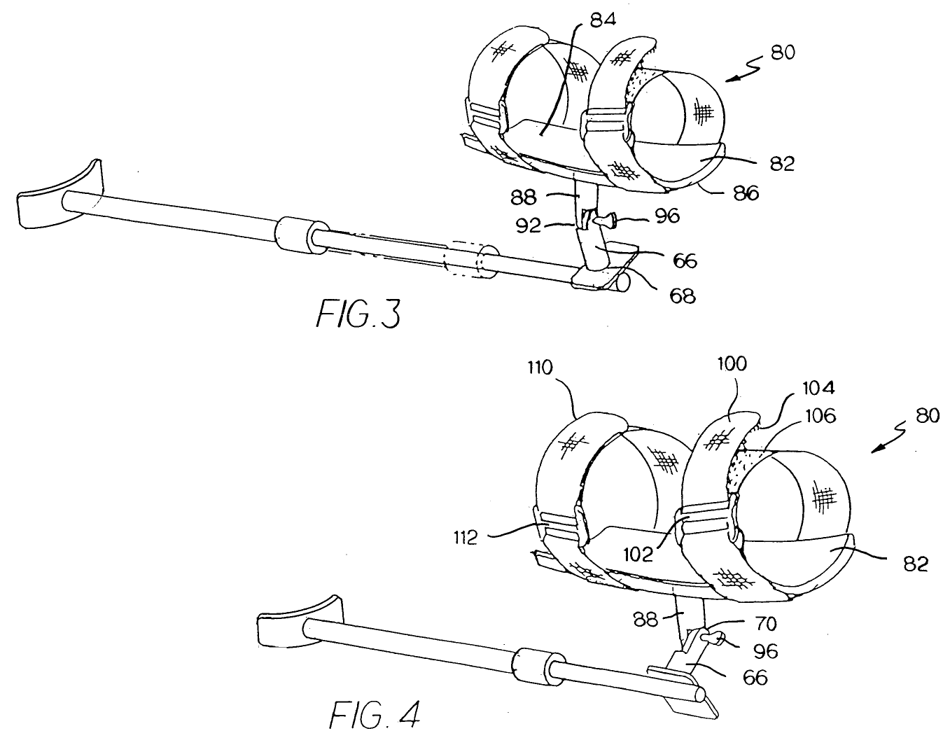

Referring to the adjustability of the support 40, FIGS. 3 and 4 illustrate the support 40 in two different positions. In FIG. 3 the telescoping arm 42 is shown in an extended position and the articulating arms 66 and 88 are shown oriented in one direction. In FIG. 4 the telescoping arm 42 is shown in a retracted position and the articulating arms 66, 88 are shown oriented in another direction. It can be seen that the support can accommodate users of different sizes, as well as right-handed users and left-handed users.

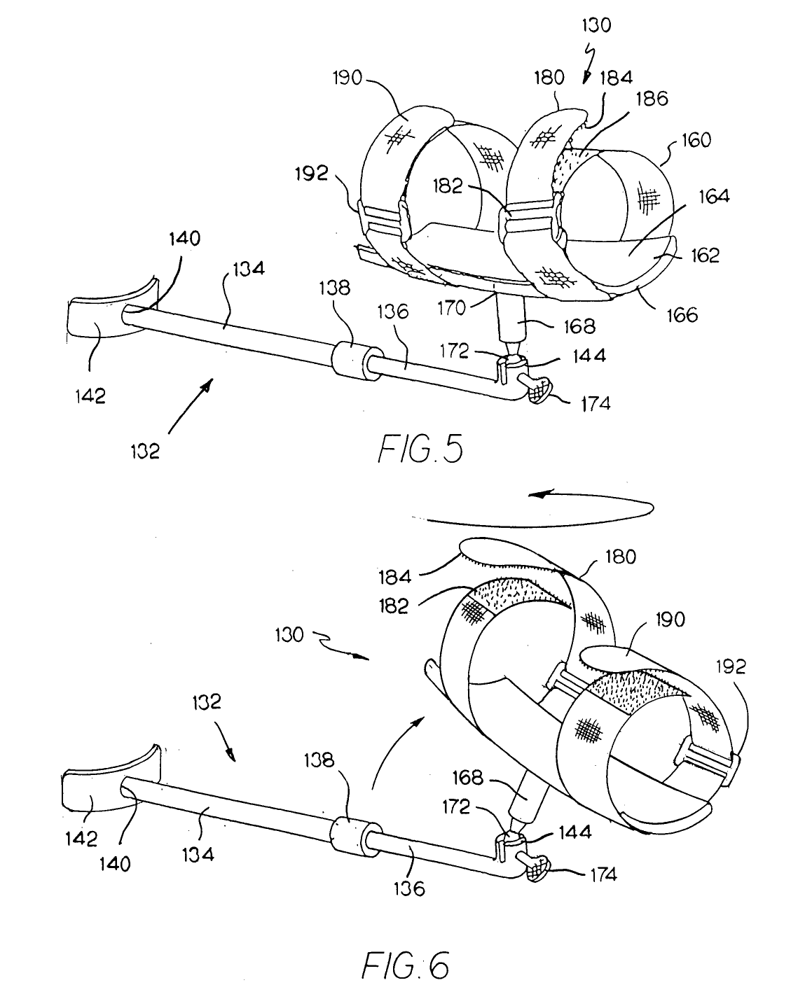

Referring to FIGS. 5 and 6, there is shown another specific embodiment of the invention. This specific embodiment has an adjustable support generally designated as 130. Support 130 has a telescoping arm 132 that has a larger diameter arm 134 and a smaller diameter arm 136. The larger diameter arm 134 is slidable (or movable) in an axial direction relative to the smaller diameter arm 136. Typically, the smaller diameter arm 136 slides inside of the larger diameter arm 134. The telescoping arm 132 also includes a locking member 138. The locking member 138 may be in one condition so that the larger diameter arm 134 is movable with respect to the smaller diameter arm 136. In the alternative, the locking member 138 may be in another condition so that the larger diameter arm 134 and the smaller diameter arm 136 are locked together.

As it can be appreciated, the axial length of the telescoping arm 132 may be adjusted to accommodate a specific user. Once the axial length has been selected, the locking member 138 is moved from the one condition to the other condition so that the larger diameter arm 134 is locked with respect to the smaller diameter arm 136.

The larger diameter arm 134 has a distal (or free) end 140 that is attached to an arcuate support (or pad) 142. As will be described later herein, the pad 142 is intended to rest against the torso or hip of the user in a fashion like that for accurate support 32 of adjustable brace 40. The smaller diameter arm 136 has a distal (or free) end 144 that contains a socket. As will be described hereinafter, the telescoping arm 132 is connected to the remainder of the support 130 via the socket at the distal end 144 of the smaller diameter arm 136.

The support 130 further includes a forearm brace 160 that comprises an arcuate cradle 162. Cradle 162 has a top surface 164 and a bottom surface 166. The forearm brace 160 further includes a depending arm 168 that depends downwardly from the bottom surface 166 thereof. The depending arm 168 is attached at its top end 170 to the bottom surface 166 of the cradle 162.

The depending arm 168 has a distal (or free) end 172 that is a ball. The ball is captive within the socket at the distal end 144 of the smaller arm 136 of the telescoping arm 132. The ball captive within the socket essentially forms a ball joint at the joinder of the depending arm 168 and the smaller diameter arm 136 of the telescoping arm 132. The relatively wide range of movement available through the use of a ball joint permits the user to essentially customize the adjustable support 130 to himself. Once the user has selected the appropriate position of the forearm brace 160 relative to the telescoping arm 132, there is a locking screw 174 that the user can tighten down to lock the ball joint. By locking the ball joint, the user secures the relative position of the telescoping arm 132 to the forearm brace 160.

The forearm brace 160 further includes one strap 180 that has a buckle 182 and opposite Velcro surfaces 184, 186. The forearm 160 also has still another (or second) strap 190 that has a buckle 192 and opposite Velcro surfaces.

To use the adjustable support 130, the user places their arm in the forearm brace 160 so that the forearm and wrist rest in the cradle 162. The straps 180 and 190 are tightened and held in place by the engagement of the Velcro straps. The ball joint then allows the user to lock the support in any one of many different positions to adjust to users of different size, as well as right-handed persons and left-handed persons. The support can also be selectively positioned so that the straps open up in the same direction or selectively positioned to open in the opposite direction.

The relative position of the forearm brace 160 and the telescoping arm 132 is selected and locked into place. The axial length of the telescoping arm 132 is then selected and locked into place.

It can thus be seen that applicant has provided a support that supports a bowhunter's arm while the bowhunter is taking aim with the bow. This support also helps steady the arm of the bowhunter. This support is also adjustable in a variety of ways so as to accommodate user's of different sizes.

All patents, patent applications, articles and other documents identified herein are hereby incorporated by reference herein. Other embodiments of the invention may be apparent to those skilled in the art from a consideration of the specification or the practice of the invention disclosed herein. It is intended that the specification and any examples set forth herein be considered as illustrative only, with the true spirit and scope of the invention being indicated by the following claims.

1. A bowhunting support for a bowhunter, the support comprising:
a cradle that receives the wrist and the forearm of the bowhunter, and a strap attached to the cradle wherein the strap secures the wrist and forearm to the cradle;
an articulating support depending from the cradle, and the articulating support having two articulating arms that articulate with respect to each other, and the articulating support further including a locking member, and the locking member being movable between a locked condition in which the articulating arms are secured from relative movement and an unlocked condition in which the articulating arms are free to move relative to each other; and
a telescoping support having an adjustable length, the telescoping support having a pad at the end thereof, and the telescoping support being connected at the other end thereof to the articulating support.

2. The bowhunting support of claim 1 further including a second strap attached to the cradle wherein the second strap helps secure the wrist and forearm to the cradle.

3. The bowhunting support of claim 1 wherein the pad presents an arcuate shape so as to conform to the hip of the bowhunter.

4. The bowhunting support of claim 1 wherein the telescoping support comprises a pair of arms that are movable with respect to each other.

5. The bowhunting support of claim 4 wherein the pair of arms are secuted together when the telescoping support is in a locked condition and movable with respect to each other when the telescoping support is in an unlocked condition.

6. The bowhunting support of claim 1 wherein the articulating support being connected to the telescoping support.

7. A support for steadying the arm of a user, the support comprising:
a cradle that receives the forearm of the user;
a support depending from the cradle;
a telescoping support having an adjustable length, the telescoping support having opposite ends, at one end is a brace; and
the depending support being pivotally connected to the other end of the telescoping support.

8. The support of claim 7 further including at least one strap connected to the cradle for securing the forearm of the user to the cradle.

9. The support of claim 7 further including a pair of straps connected to the cradle for securing the forearm of the user to the cradle.

10. The support of claim 7 wherein the telescoping support comprises a pair of arms that are movable with respect to each other.

11. The support of claim 10 wherein the pair of arms are secured together when the telescoping support is in a locked condition and movable with respect to each other when the telescoping support is in an unlocked condition.

12. The support of claim 7 further including a locking member for locking the depending support in a pre-selected position when the locking member is in a locked condition.

13. The support of claim 12 wherein the depending support is free to pivot with respect to the telescoping support when the locking member is in an unlocked condition.

14. A support for steadying the arm of a user, the support comprising:
a cradle that receives at least a part of the user's arm between the elbow and the wrist so as to include the wrist;
a first adjustable support extending from the cradle, the first adjustable support having two arms that are movable with respect to each other, and a locking member that selectively locks the two arms from relative movement with respect to each other; and
a second adjustable support having opposite ends wherein the axial length of the second adjustable support is adjustable, one end having a pad attached thereto and the other end being attached to the first adjustable support.

15. The support of claim 14 further including at least one strap connected to the cradle for securing the forearm of the user to the cradle.

16. The support of claim 14 further including a pair of straps connected to the cradle for securing the forearm of the user to the cradle.

17. The support of claim 14 wherein the second adjustable support comprises a pair of arms that are movable with respect to each other.

18. The support of claim 17 wherein the pair of arms are secured together when the second adjustable support is in a locked condition and movable with respect to each other when the telescoping support is in an unlocked condition.

19. The support of claim 14 wherein the pad presents an arcuate shape.
